(19) United States
(12) Patent Application Publication
(10) Pub. No.: US 2019/0313596 A1
(43) Pub. Date: Oct. 17, 2019

(54) Automatic Self-Cleaning Animal Litter Apparatus

(71) Applicant: Louis Cornacchia, Point Lookout, NY (US)

(72) Inventor: Louis Cornacchia, Point Lookout, NY (US)

(21) Appl. No.: 16/386,235

(22) Filed: Apr. 16, 2019

Related U.S. Application Data
(60) Provisional application No. 62/658,335, filed on Apr. 16, 2018.

(51) Int. Cl. A01K 1/01

(52) U.S. Cl. CPC A01K 1/0117

(57) ABSTRACT

The present invention is an automatic self-cleaning animal litter apparatus using a hopper/spout assembly and conveyer belt mechanism. The litter apparatus includes a conveyer belt that is controlled using a sensor and controller. The hopper stores fresh litter to be deposited onto the conveyer belt. The spout assembly provides thickness and location control of the fresh litter deposited onto the conveyer belt. A conveyer belt cleaning device underneath the conveyer belt mechanism rids the conveyer belt of the used litter and feces which are then dropped into the receptacle.

### FIELD OF THE INVENTION

The present invention generally relates to a litter box with self-cleaning functionality. The present invention is directed to an animal waste management device that uses a conveyer belt as the surface area for animals to defecate and urinate and, when activated, transports fecal matter and any associated litter material from the exposed surface to a container below returning a clean exposed surface with fresh litter material.

### BACKGROUND OF THE INVENTION

Animals, particularly cats, defecate onto litter material placed in a box. The litter absorbs urine and allows animals to cover feces in litter material. This simple, but widely seen type of litter box has many limitations. Some of which deal with the user requiring manual upkeep of the device for optimal function. The most inconvenient drawback of these simple litter boxes is that the user must replace the litter manually after each or a certain amount of uses. Another issue is that if the user is not available for the upkeep of the litter box, the feces and urine accumulate on the litter, resulting in a repulsive litter box that the animal will not use. To solve these and various other issues, many inventions have been created, most of which rely on a conveyer belt mechanism to transport fresh litter and discard used litter. These inventions include a brush-type component to clean the belt of the used litter and feces, a hopper to allow for manual feeding of fresh litter onto the conveyer belt, and a sensor with an integrated circuit for autonomous functionality. However, even these inventions have not been perfected and include various drawbacks that render them too large, too expensive, difficult to operate, difficult to manually clean, and do not provide adequate conveyer belt cleaning.

An objective of the present invention is to provide vast improvements on existing conveyer belt litter boxes to redress the issues stated earlier. The present invention includes a newly-developed cleaning system. A large number of previous inventions have used brushes and water jets. However, a water jet is cumbersome, requires a plumber to set up and is expensive to build, purchase and maintain. In addition, feces can easily accumulate on a brush, thus rendering it useless and difficult to clean. The present invention includes a tube-plate component with a slippery coating to provide adequate contact with the belt while reducing the accumulation of feces on the conveyer belt conveyer belt cleaning device. This cleaning system also allows the use of any type of litter, including clumping litter. This cleaning system also causes litter to be more evenly distributed to the receptacle below. This cleaning system does not require cleaning, it is self-cleaning and it allows for the belt to be cleaned from the exposed top surface with a wet cloth.

The present invention provides an easier method of manual cleaning. A controller and relay, which control the automation of the present invention, are housed in a separate snap-on, sealed electronics box that can be left in place when the invention requires manual cleaning. In addition, a receptacle with a bin that contains the used litter can be covered with a bag, thus the user would simply need to replace the bag once full. Further, the conveyer mechanism and all controlling electronics are removable and separately washable, maintainable. The conveyor mechanism is self-contained as it contains all electronics and components required for the functioning of this apparatus. Therefore, the mechanism can be embedded into expensive furniture, etc., and maintained, repaired or replaced as needed with discarding the furniture or supporting external structure.

In order for litter on the conveyer belt to travel to the underside of the conveyer belt mechanism, there must be a tall enough clearance such that the litter does not get caught to the side of the invention. Other inventions raise the height of the invention to avoid this issue. However, this adds to the height of the litter box and can make it more difficult to animals to reach. To address this issue, the conveyer belt on the present invention is angled to provide the appropriate clearance while removing the need to increase the height of the present invention. This also facilitates drainage of liquid waste such as urine and solid waste such as feces, without litter, since the flow is downward with gravity. Furthermore, in other inventions the conveyer belt can slip if there is even a slight resistance. This can result in an uneven layer of litter on the conveyer belt as well as an incompletely cleaned conveyer belt due to the reduced amount of rotation. To redress this issue, the present invention includes a spring-loaded tensioner on a secondary passive roller and an integrated cleaning mechanism which adds to tensioning the belt to greatly reduce the chance of conveyer belt slippage while maintaining minimal cost. Drapes are added to where the conveyer belt enters and exits the defecation area to prevent animals from shying away from the seeing the inside of the present invention while also keeping the odor contained within the receptacle. The drapes also prevent animals from dispersing the litter into the receptacle below and so that litter flowing from the hopper does not flow over the edge of the belt, on the drive roller side, and directly into the waste receptacle.

Finally, the present invention includes a novel method of depositing fresh litter onto the conveyer belt. A hopper is designed with variable spout thicknesses and a control valve to allow the user to precisely control the amount and location of litter that is deposited on the conveyer belt. This spout mechanism can be lowered directly onto the belt to minimize the depth of the litter deposited onto the belt or it can be elevated to increase the depth of the litter deposited onto the belt. This reduces the amount of litter that needs to be bought, thus saving time and money while allowing for thicker litter as a matter of user preference or during the early phase of acclimating the animal.

### SUMMARY OF THE INVENTION

The present invention is an automatic self-cleaning animal litter apparatus using an enclosure, a hopper, a spout assembly inside the hopper, and a conveyer belt mechanism with all required electronics and drive mechanisms in one self-contained unit. The enclosure provides a litter opening that is where an animal can urinate and/or defecate. The enclosure also provides housing for a receptacle to receive the animal waste. A plurality of drapes can be attached to the inter edges to prevent the odor of the animal waste from escaping the enclosure. The hopper, located on top of the enclosure adjacent to the litter opening, can store fresh litter and provide desired litter through the use of the spout assembly which is mounted to the interior side of the hopper. The spout assembly provides thickness and location control of the fresh litter deposited onto the conveyer belt through either a control valve and a plurality of spouts, or a sliding channel spout. The conveyer belt is located inside the enclosure beneath the litter opening and is controlled using a sensor and controller. When the sensor detects the animal using the apparatus, the controller automatically starts the sequence of operations of moving the conveyer belt, removing used litter, and depositing fresh litter onto the conveyer belt. A conveyer belt cleaning device underneath the conveyer belt mechanism rids the conveyer belt of the used litter and feces which are then dropped into the receptacle.

### BRIEF DESCRIPTION OF THE DRAWINGS

FIG. 1 is a perspective view of the present invention.

FIG. 2 is a front view of the present invention.

FIG. 3 is a right view of the present invention.

FIG. 4 is a top view of the present invention.

FIG. 5 is a left view of the conveyer belt mechanism showing the motor assembly of the present invention.

FIG. 6 is a perspective view of conveyer belt mechanism of the present invention.

FIG. 7 is an exploded perspective view of the conveyer belt mechanism illustrating the direct motor drive of the present invention.

FIG. 8 is a right view of the conveyer belt mechanism.

FIG. 9 is a bottom view of the conveyer belt mechanism.

FIG. 10 is a front view of hopper of the present invention showing the cross-sectional cut of D-D.

FIG. 11 is a right, cross-section view of the cut D-D of the hopper of the present invention.

FIG. 12 is a top view of the hopper of the present invention.

FIG. 13 is a top view of the spout of the hopper of the present invention.

FIG. 14 is a perspective view of an alternative embodiment of the present invention.

FIG. 15 is a top view of the alternative embodiment of the present invention showing the sectional cut of A-A.

FIG. 16 is a left, cross-sectional view of the cut A-A of the alternative embodiment of the present invention.

FIG. 17 is an exploded perspective view of the alternative embodiment of the present invention.

FIG. 18 is a perspective view of the alternative embodiment of the hopper and the top plate of the present invention.

FIG. 19 is an exploded perspective view of the alternative embodiment of the hopper and the top plate of the present invention.

FIG. 21 is a perspective view of the alternative embodiment of the conveyer belt mechanism of the present invention.

FIG. 22 is a bottom view of the alternative embodiment of the hopper and the top plate of the present invention.

FIG. 23 is an electrical diagram of the present invention.

FIG. 24 is the control logic flowchart used by the controller.

### DETAIL DESCRIPTIONS OF THE INVENTION

All illustrations of the drawings are for the purpose of describing selected versions of the present invention and are not intended to limit the scope of the present invention.

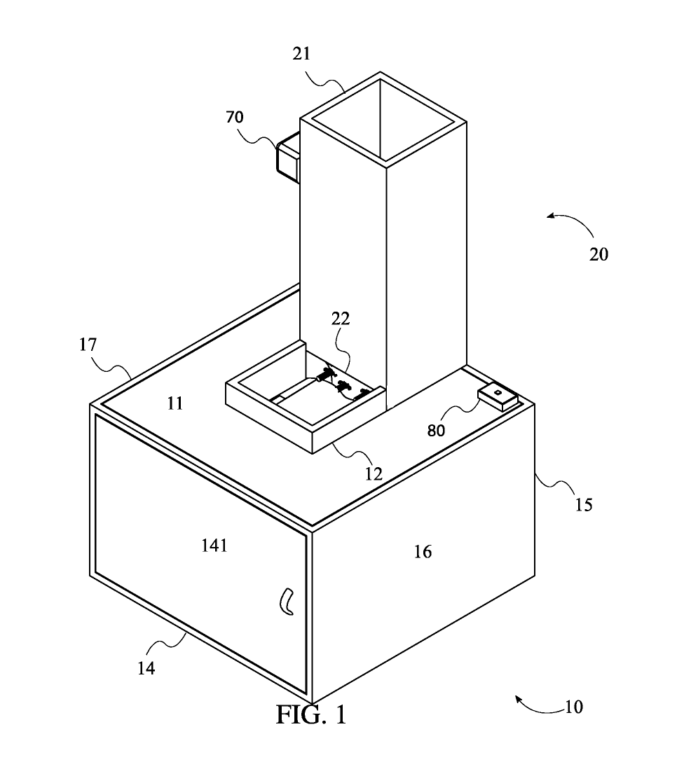

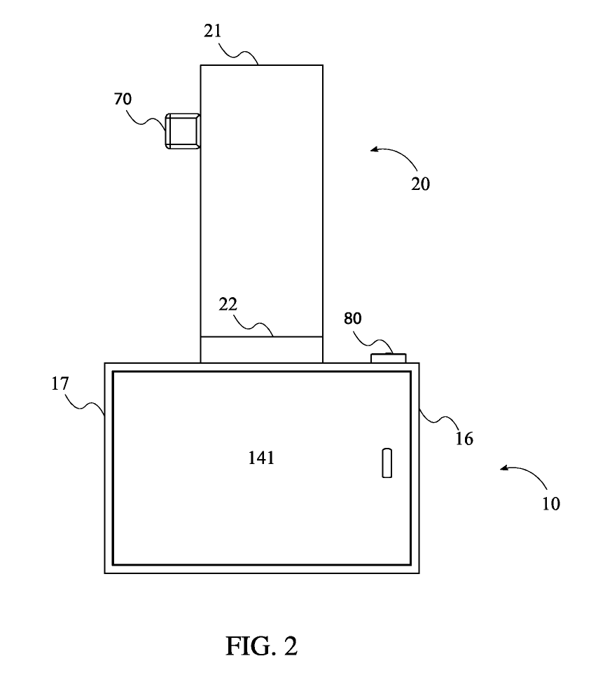

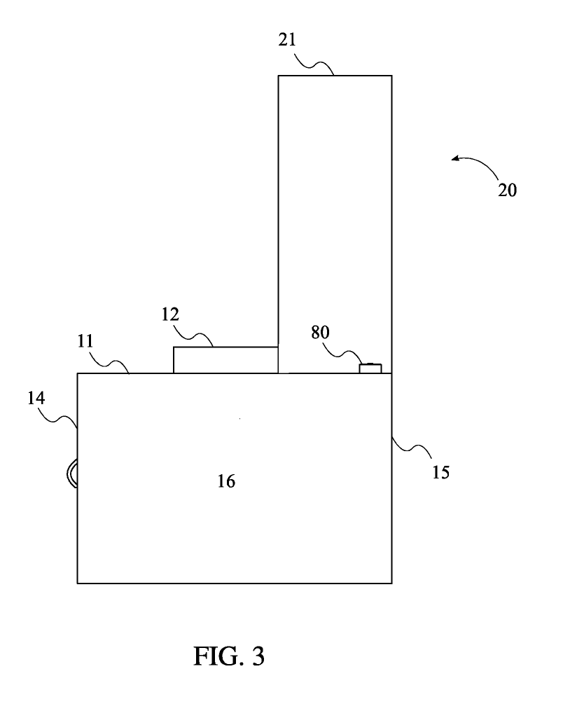

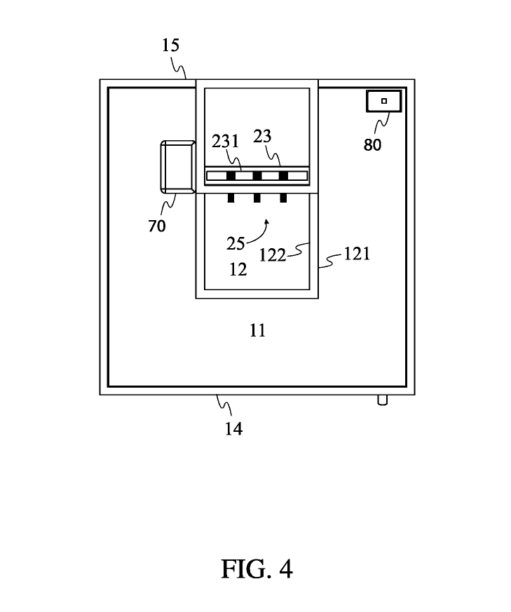

As illustrated in FIG. 1 to FIG. 5, the present invention comprises an enclosure 10, a hopper 20, and a conveyer belt mechanism 40. The hopper 20 is terminally connected to the enclosure 10, which provides housing for the conveyer belt mechanism 40. Additionally, the enclosure 10 and the conveyer belt mechanism 40 offer the main function of defecation and urination to an animal user and the removal of used litter from the apparatus while the hopper 20 is used to supply fresh litter for the apparatus of the present invention.

As seen in FIG. 1 to FIG. 5, the enclosure 10 comprises a top plate 11, a litter box opening 12, a drawer 13, a front 14, a back 15, a first side 16, a second side 17, and a receptacle 18. The top plate 11 is terminally connected to and supported by the front 14 and back 15. The litter box opening 12 is positioned on the top plate 11. The animal user can rest on top of the litter box opening 12 and defecate and urinate. Additionally, the litter box opening 12 is made from a plurality of litter box walls 121, as seen in FIG. 1. In the preferred embodiment, the litter box opening 12 can be, but is not limited to a square. The litter box opening 12 features a plurality of drapes 122 attached to the plurality of litter box walls 121 that covers the internal components of the present invention and contains the odor of the used litter. The plurality of drapes 122 can be made from, but is not limited to, a fabric, rubber or synthetic, elastic material or a sturdy material. The first side 16 and the second side 17 are terminally mounted to the front 14 and the back 15. Further, the drawer 13 is interiorly mounted to the front 14 of the enclosure 10 through the first side 16 and the second side 17 to allow a user to access to the receptacle 18. In another embodiment of the present invention, the front 14 of the enclosure 10 comprises hinged door 141 and a plurality of hinges 141. The hinged door 141 is mounted to the front 14 through the plurality of hinges 142, which is mounted to the front 14 adjacent the top plate 11 of the enclosure 10. The receptacle 18 is removably positioned inside the enclosure 10 beneath the conveyer belt mechanism 40. Additionally, the receptacle 18 can be, but is not limited to, a bin, a container, a waste can, a bag, etc., to collect the used litter. The user can also insert a bag inside the receptacle 18 to easily remove the used litter.

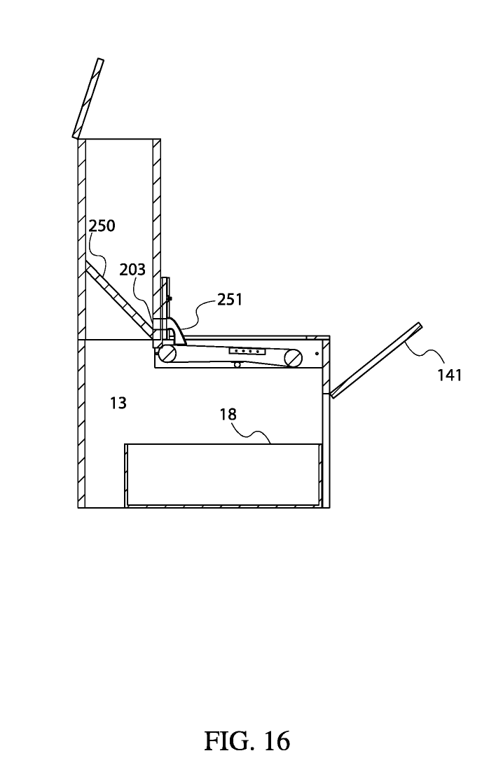

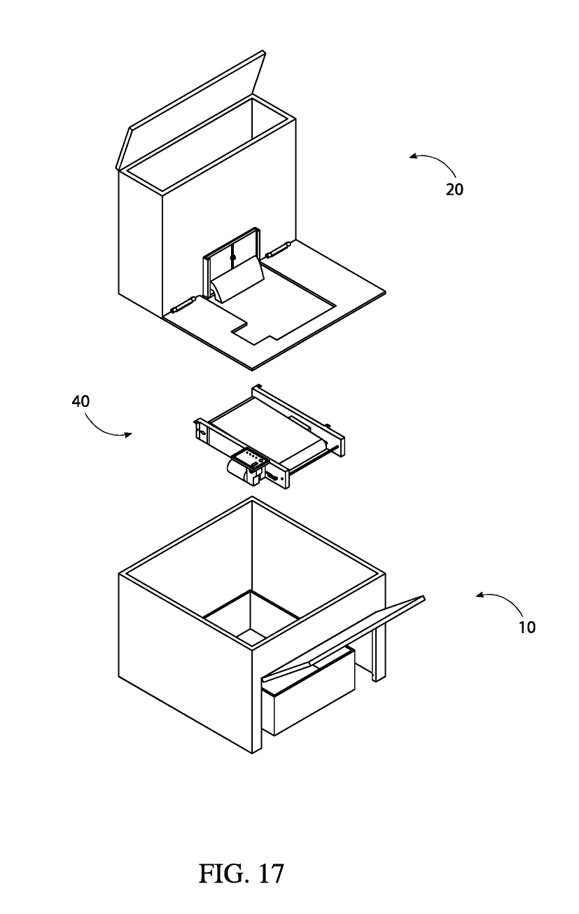

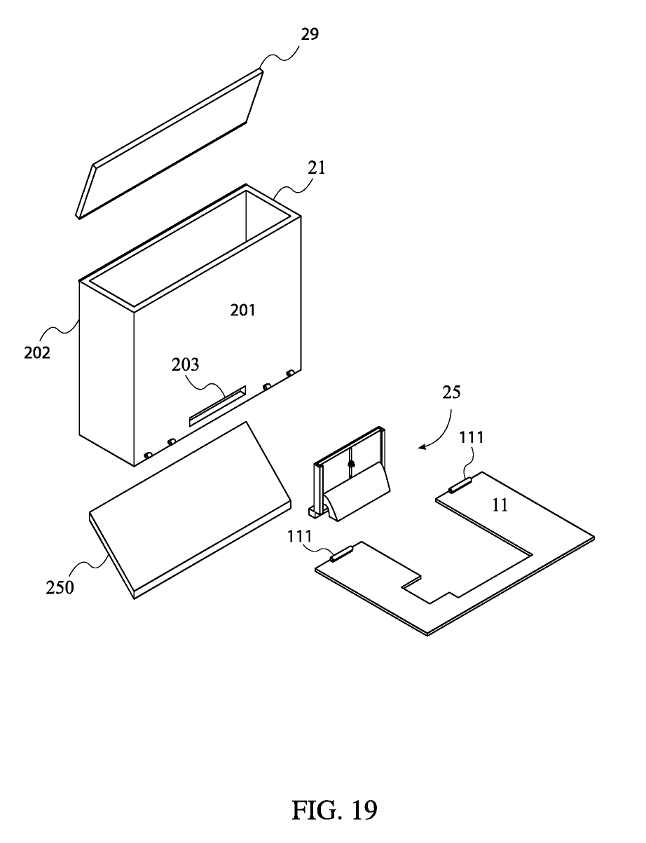

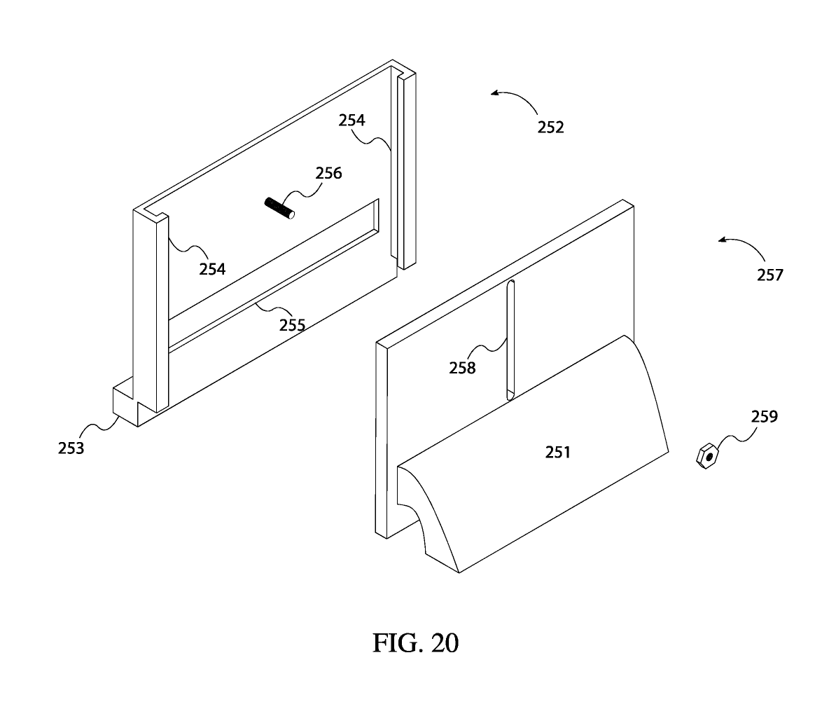

In an alternative embodiment, the top plate 11 of the enclosure 10 comprises a plurality of plate hinges 111, as seen in FIG. 14 to FIG. 19. Instead of being connected to and supported by the front 14 and back 15 of the enclosure, the top plate 11 is terminally connected to the hopper 20 through the plurality of plate hinges 111.

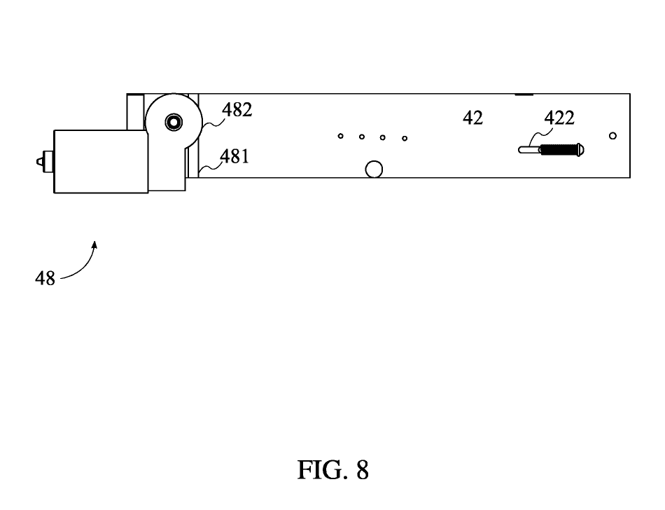

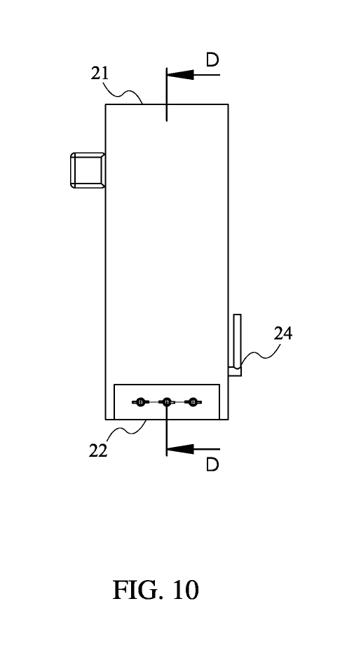

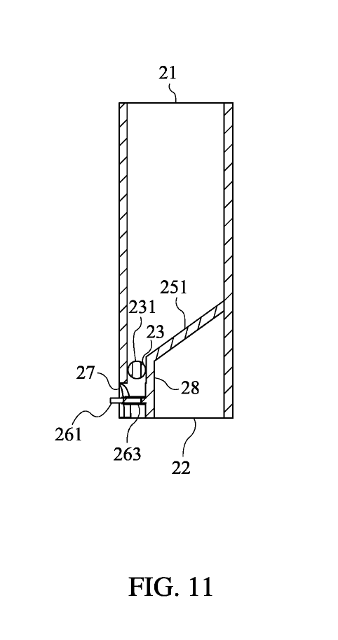

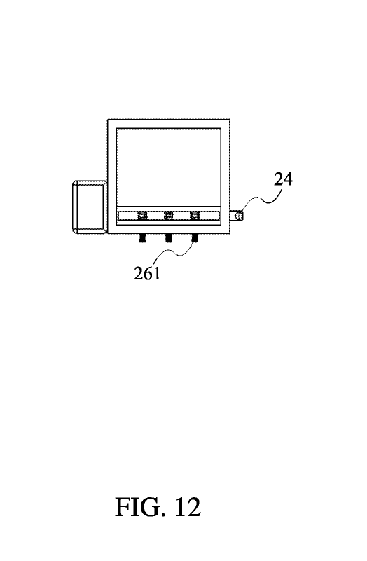

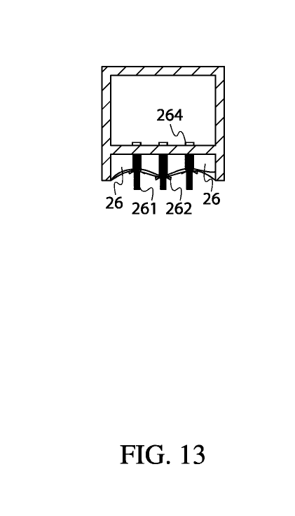

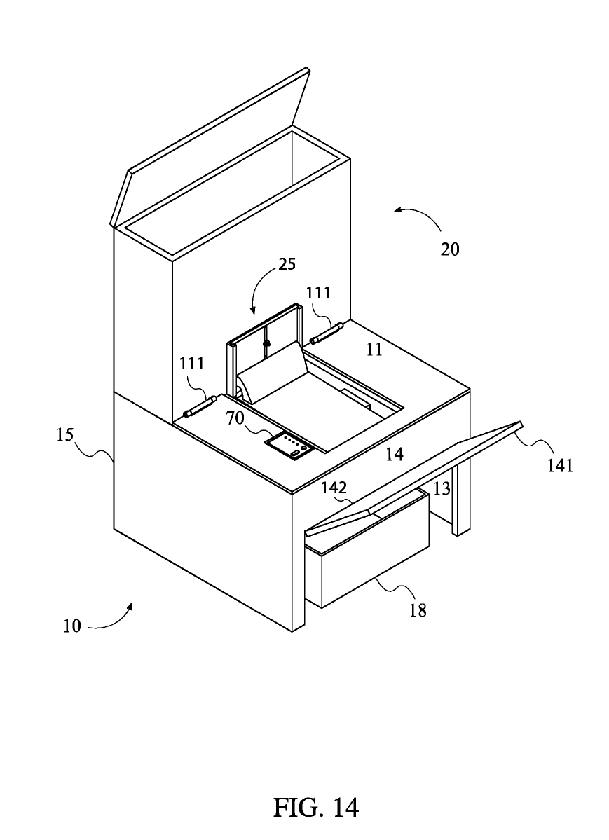

As seen in FIG. 1 to FIG. 13, the hopper 20 is connected to the top plate 11 and integrated to the side walls of the enclosure 10 and is used to store and deposit fresh litter onto the conveyer belt assembly 40. Additionally, the hopper may be, but is not limited to, a cuboid, round, or oval-shaped structure with open ends. The hopper 20 comprises a feed 21, an exit 22, and a spout assembly 25. More specifically, the exit 22 is positioned between the edge of the litter box opening 12 and the back 15 of the enclosure 10. The feed 21 is terminally positioned on the hopper 20, opposite the exit 22. The feed 21 is where the user inserts fresh litter to be stored. As seen in FIG. 13, the feed 21 comprises a hinged cover 29 which is terminally mounted onto the hopper 20. Further, the feed 21 is closed with hinged 29 to prevent the animal user from attempting to use exposed litter. The litter will fall down the hopper 20 until it reaches spout assembly 25. The spout assembly 25 comprises a plurality of spouts 26, a control valve 24, a flexible wall 27, and a plurality of non-flexible walls 28. The control valve 24 is interiorly mounted to the hopper 20 adjacent the exit 22. The plurality of spouts is perpendicularly connected to the control valve 24, and is extended over the litter box opening 12 of the enclosure 10. The control valve 24 is mounted to the hopper 20 adjacent the exit 22 of the hopper 20. Additionally, the control valve 24 comprises a manual control lever 24 and a slot 231. The manual control lever 24 is perpendicularly mounted to the control valve 24 and is positioned outside the hopper 20. Further, the slot 231 is longitudinally positioned across the control valve 24 and traverses the control valve 24. The control valve 24 can include, but is not limited to, a circular rod, however, the rod and the slot 231 can be any shape and size. As seen in FIG. 10 and FIG. 12, the control valve 24 is in a vertical, open setting, with the slot fully visible; thus, the litter can travel through the slot 231 down to the spout assembly 25. As seen in FIG. 8 to FIG. 10, when the user rotates the manual control lever 24 clockwise to a horizontal position, the slot 231 simultaneously rotates until horizontally aligned with the manual control lever 24. In this setting, the litter is restricted from further flowing down to the spout assembly 25. The manual control lever 24 can be rotated to any other intermediate position to allow any specific rate of litter to pass through the control valve 24. Each of the plurality of spouts 26 comprises a fastener 261, a fastener head 262, a spring 263, and a bearing 264. As seen in FIG. 10 to FIG. 13, the spout assembly 25 can include, but is not limited to, a rectangular shaped opening that controls the amount and location of litter deposited onto the conveyer belt assembly 40. The flexible wall 27 can be made from a flexible yet durable material, serving a secondary purpose to close off the litter box opening 12. The other three sides of the spout assembly are the plurality of non-flexible walls 28, which can be made from metal, wood, or any other sturdy material, etc. One of the plurality of non-flexible walls 28 is positioned inside the hopper 20 at an angle with one side on the back 15 being elevated higher than the other side. As seen in FIG. 12 to FIG. 13, outside of the spout assembly 25 along one of the plurality of non-flexible walls 28 that is opposite to that of the flexible wall 27 includes the fastener head 262 that secures the fastener 261 on one side. The fastener 261 travels through the spring 263 and finally through the flexible wall 27 and is secured using the bearing 264. The spring 263 ensures that the flexible wall 27 stays adhered to the bearing 264. To change the amount and location of litter deposited onto the conveyer belt assembly 25, the user simply rotates the bearing 264 to close or open the plurality of spouts 26. In the preferred embodiment of the present invention, the number of the spouts for the plurality of spouts 26 can include, but is not limited to, three or one with each comprising multiple channels, linearly arranged, however, the present invention can have any number of spouts in any arrangement. As seen in FIG. 12 to FIG. 13, the two spouts of the plurality of spouts 26 are in a closed setting and one spout of the plurality of spouts 26 is in an open setting. In this arrangement, the fresh litter will only deposit onto the middle of the conveyer belt assembly 40 with a maximum stream width. It is also possible to have any intermediary position of the plurality of spouts 25 for any combination of stream widths. The litter is deposited onto the conveyer belt assembly 40 and departs the hopper 20 via the exit 22. The exit 22 is the area between the lower end of the flexible wall 27 of the spout assembly 25 and the conveyer belt assembly 40. The height of the exit 22 of the hopper 20 determines the thickness of the layer of fresh litter deposited on the conveyer belt assembly 40. A larger height of the exit 22 results in a thicker layer of litter. The present invention is not limited to any specific height of the exit 22 of the hopper and the exit height can be made variable via any appropriate mechanism.

In the alternative embodiment, as seen in FIG. 14 to FIG. 19, the hopper 20 comprises a hopper front 201, a hopper back 202, a hopper slot 203, and a slant board 250. More specifically, the hopper back 202 is oriented flush to the back 15 of the enclosure 10. The hopper front 201 is oriented perpendicular to the feed 21 opposite to the hopper back 202. Additionally the hopper front 201 is facing the litter box opening 12 of the enclosure 10. The hopper slot 203 is longitudinally positioned across the hopper front 201, adjacent the exit 22. Further, the slant board 250 is positioned within the hopper front 201 and the hopper back 202 in an angle with the back side elevated. Additionally, the slant board 250 traverses the interior of the hopper 20 from side to side creating a litter flow path from the feed 21 to the hopper slot 203. As seen in FIG. 14 to FIG. 20, the spout assembly 25 comprises a channel spout 251, a base board 252, a positioning block 253, a plurality of sliding channels 254, a spout slot 255, a threaded rod 256, a sliding board 257, a sliding slot 258, and a fastening nut 259. More specifically, the spout slot 255 is longitudinally positioned across the base board 252. The positioning block 253 is terminally and longitudinally connected to the base board 252, adjacent the spout slot 255. Each of the plurality of sliding channels 254 is terminally and laterally positioned on the base board 252. The threaded rod 256 is centrally positioned on the base board 253, adjacent to the sliding slot 257. The base board 252 is mounted to the hopper front 201 of the hopper 20 using any fastening means including, but not limited to screws, nails, bolts and nuts, etc. Additionally, the base board 252 is positioned with the positioning block 253 against the exit 22 of the hopper 20, thus, providing alignment of the spout slot 255 and the hopper slot 203 of the hopper 20. The channel spout 251 is terminally and longitudinally connected to the sliding board 257 adjacent the sliding slot 258, which is centrally and laterally positioned on the sliding board 257. Additionally, the interior of the channel spout 251 can include, but is not limited to, a L-shape channel, an arc shape channel, an partial ellipse shape channel, or any suitable shape channel. Further, the area of the sliding board 257 where the channel spout 251 is connected to is opened up. Additionally, the end of the channel spout 251 opposite the sliding board 257 is oriented above the litter box opening 12 of the enclosure 10. The fastening nut 259 fastens the sliding board 257 onto the base board 252 through the threaded rod 256 after the sliding board 257 is installed inside the plurality of sliding channels 254 of the base board 252. Additionally, the fastening nut 259 can comprise, but is not limited to, a wing nut, a cap nut, or any other suitable nut. Further, the height of the sliding board 257 with respect to the base board 252, which is mounted on the hopper 20, can be adjusted by loosening the fastening nut 259, sliding up and down the sliding board 257 along the plurality of sliding channels of the base board 252, and fastening the fastening nut 259 back to the threaded rod 256. By adjusting this height, the user can achieve a desired thickness of the fresh litter deposited onto the drive belt 25 of the conveyer belt mechanism 40.

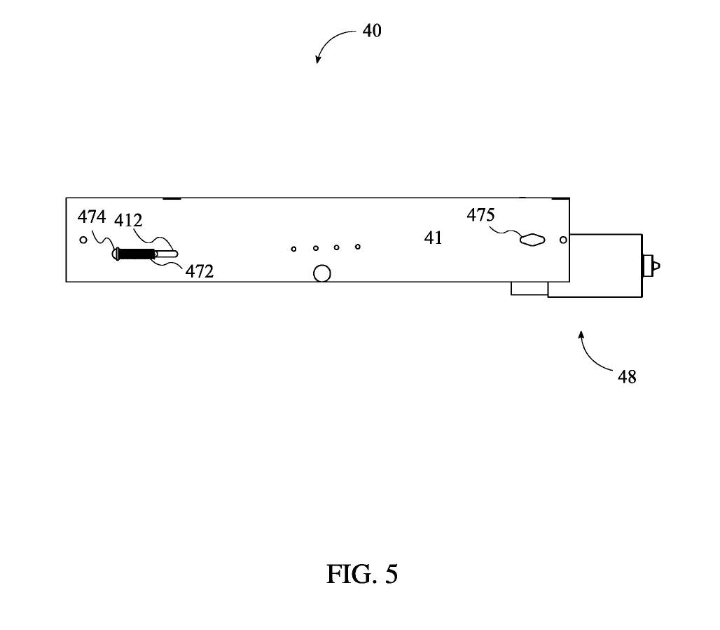

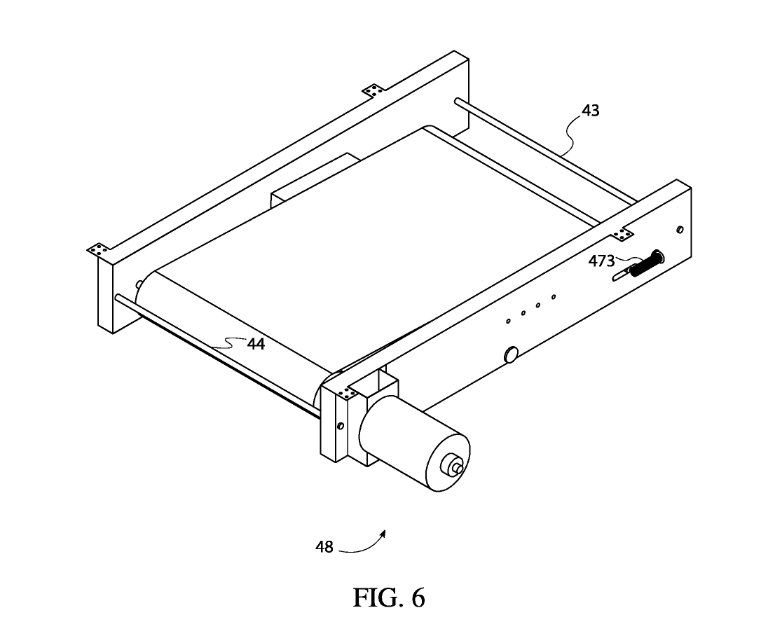

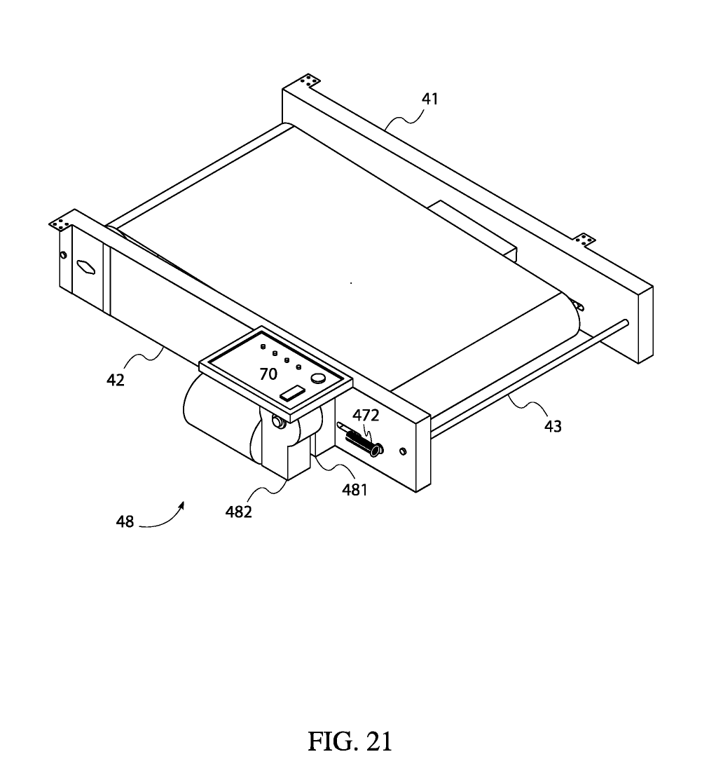

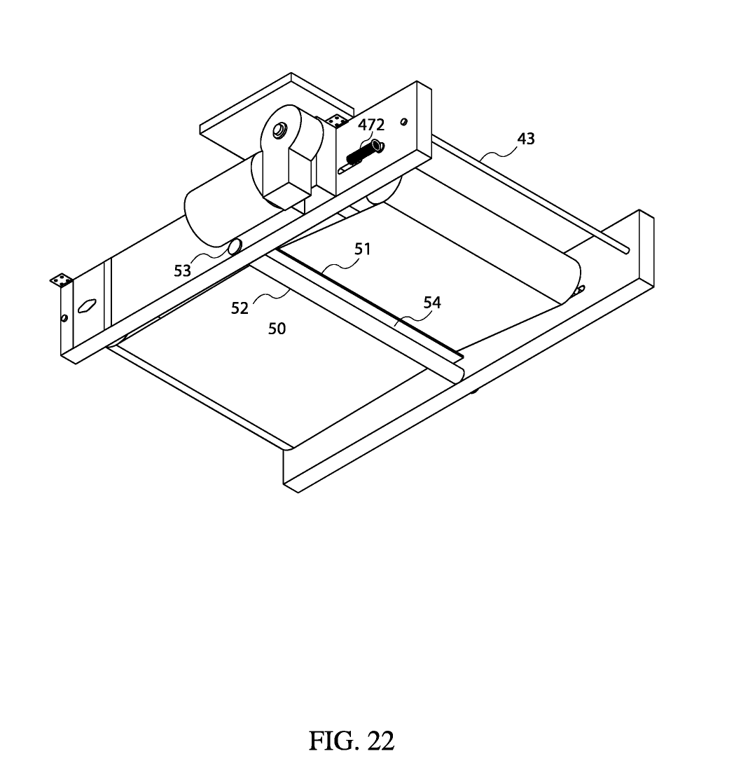

As can be seen in FIG. 5 to FIG. 9, FIG. 14 to FIG. 17, and FIG. 21 to FIG. 22, located inside the enclosure 10 is the conveyer belt mechanism 40. More specifically, the conveyer belt mechanism comprises a first support panel 41, a second support panel 42, a first structural support 43, a second structural support 44, a drive belt 45, a drive roller 46, a passive roller 47, a motor assembly 48, a plurality of support mounts 49, a conveyer belt cleaning device 50, a control box 70, and an electronic box 80. The components of the conveyer belt mechanism 40 are held together via the first support panel 41, the second support panel 42, the first structural support 43, and the second structural support 44.

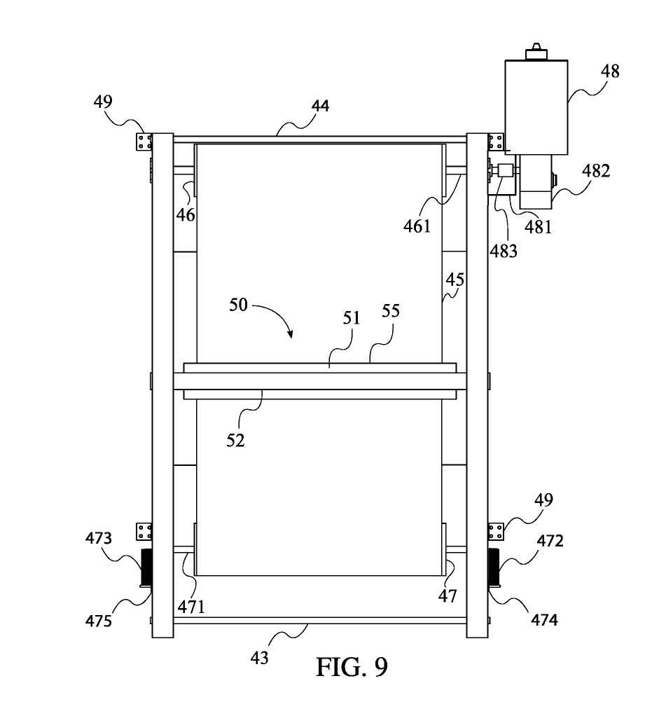

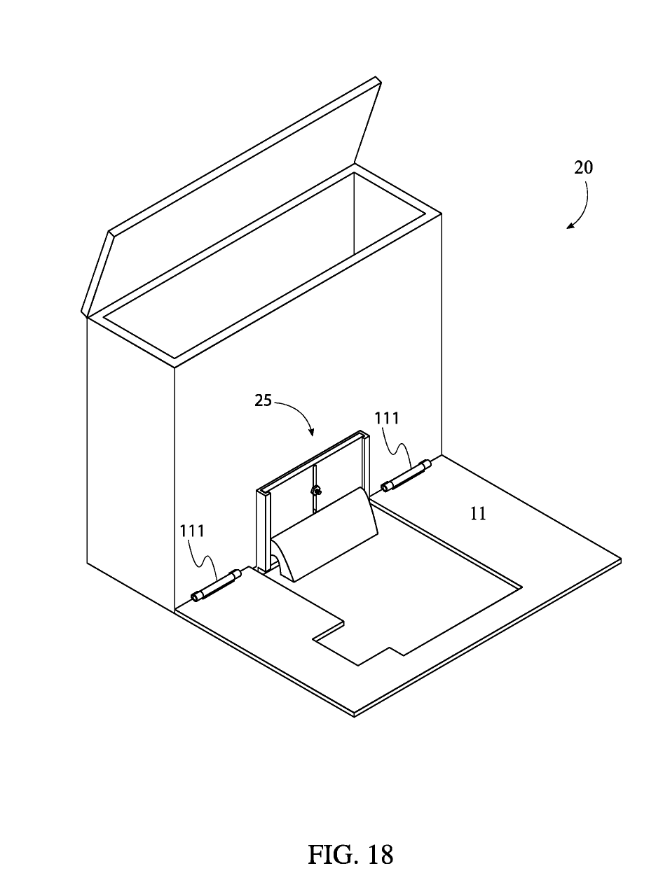

As seen in in FIG. 9, FIG. 17, and FIG. 21 to FIG. 22, the first support panel 41 and the second support panel 42 are mounted on and positioned across the top plate 11 of the enclosure 10 opposite to the hopper 20. Additionally, the first support panel 41 and the second support panel 42 are positioned on either side of the drive belt 45 parallel to the direction the drive belt 45 moves. Further, the first support panel 41 comprises a first sliding slot 412, and the second support panel comprises a second sliding slot 422. Each of the drive roller 46 and passive roller 47 is mounted within the first support panel 41 and the second support panel 42, adjacent each end of the first support panel 41and the second support panel 42, oriented such that the drive roller 46 is positioned under the hopper 20. The drive belt 45 is then wrapped around the drive roller 45 and the passive roller 47. Additionally, the drive belt 45 is positioned beneath the exit 22 of the hopper 20 and stretched across the entire length of the litter box opening 12 of the enclosure 10. The drive roller 46 comprises a drive roller axle 461, a first drive roller bearing 462, and a second drive roller bearing 463. Each of the first drive roller bearing 461 and the second drive roller bearing 462 are terminally and concentrically connected to either end of the drive roller axle 461. The passive roller comprises a passive roller axle 471, a first tensioning spring 472, a second tensioning spring 473, a first passive roller bearing 474, and a second passive roller bearing 475. Each of the first passive roller bearing 474 and the second passive roller bearing 475 are terminally and concentrically connected to either end of the passive roller axle 471. Additionally, the drive roller 46 and the passive roller 47 are connected to the first support panel 41 and second support panel 42 through the drive roller axle 461 and passive roller axle 471, respectively. Often, conveyer mechanisms involve a second passive roller which is also spring-loaded to manage tension and absorb variations in tension on the drive belt 45. The apparatus of the present invention is enabled to avoid this added feature and expense with the development of the conveyer belt conveyer belt conveyer belt cleaning device 50 that also serves as a tensioning device. The drive roller 46 is secured to the second support panel through the second drive roller bearing 463. The passive roller 47 is rotationally mounted to the first support panel 41 and second support panel 42 through the passive roller axle 471. The main function of the passive roller 47 is to provide additional support to hold the drive belt 45 in aid of the drive roller 46. A secondary purpose for the passive roller 47 is to provide tension to the drive belt 45 to ensure that the drive belt 45stays firmly taught throughout the use cycle. This is accomplished via the first tensioning spring 472 and second tensioning spring 473. The first tensioning spring 472 and second tensioning spring 473 are positioned adjacent to the passive roller 47 on the side opposite the drive roller 46. One end of the first tensioning spring 472 and second tensioning spring 473 is connected to the first support panel 41 through the first sliding slot 412 and second support panel 42 through the second sliding slot 422, respectively. The other end of the first tensioning spring 472 and second tensioning spring 473 is attached to the ends of the passive roller axle 471. As the weight on the drive belt 45 increases based on the amount of litter and the amount of feces and urine, the passive roller 45 is pulled towards the drive roller 47. This movement ensures that the drive belt 45 on the drive roller 46 and passive roller 47 remains taught and reduces the chance of slippage. Also, each of the first tensioning spring 471 and the second tensioning spring 472 can be attached to each of the first support panel 41 and the second support panel 42 by way of an eye bolt/screw or similar fastening method to vary tension on the passive roller 47 and thereby the drive belt 45.

As can be seen in FIG. 5 to FIG. 8, FIG. 17, and FIG. 21 to FIG. 22, on the outer side of the first support panel 41, which is opposite to where the drive roller axle 461 is attached, is located the motor assembly 48. The motor assembly 48 further comprises a motor mount 481, a gear box 482, a motor 483, and a drive roller axle connector 484. The first drive roller bearing 462 is connected to the drive roller axle connector 484. This drive roller axle connector 484 transfers the rotational energy from the motor 483 to the drive roller 46 to rotate the drive belt 45. The motor 483, which includes a gearbox 482, is directly connected to the drive roller axle connector 484 and held to the first support panel 41 via the motor mount 481. Alternatively, the motor 483 can be mounted directly to the first support panel 41 to reduce cost and reduce size of the conveyer belt mechanism 40. Alternatively, the motor 483 can be mounted on the first support panel 41 and connected to the drive roller axle 461 directly or via pulley, worm drive, chain, gears or any other such mechanism.

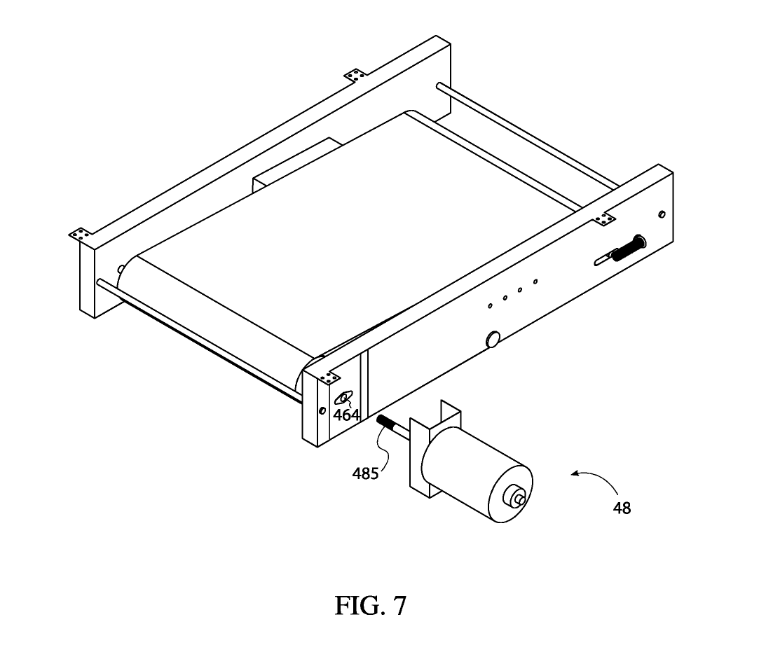

In the alternative embodiment of the present invention, as seen in FIG. 6 to FIG. 7, the motor assembly is directly connected to the drive roller 46 through the drive roller axle 461. More specifically, the driver roller axle 461 comprises a driver roller threaded hole 464, and the motor 483 comprises a motor threaded shaft 485. The motor 483 is mounted to the motor mount 481, which is mounted to the first support panel 41. Further, the motor 483 is then concentrically and terminally connected to the drive roller 46 by engaging the motor threaded shaft 485 with the drive rall threaded axle 464 in order to to reduce cost, likelihood of failure.

The drive belt 45 is held in place by the drive roller 46, the passive roller 47, the first support panel 41, and the second support panel 42. The passive roller 47 is positioned slightly lower than the drive roller 46 to provide clearance, creating a downward tilt. This allows the litter to pass under the plurality of litter box walls 121 of the enclosure 10, while also serving as a supporting platform that helps the litter and waste products be transported down into the receptacle 18 using gravity. The first support panel 41 and second support panel 42 are held together by the first structural support 43 and second structural support 44 positioned on the two ends of the first support panel 41 and second support panel 42, as seen in FIG. 9. The first structural support 43and second structural support 44 can include, but are not limited to, threaded rods that secure the ends to the first support panel 41 and second support panel 42. As seen in FIG. 9, the first structural support 43 is located adjacent to the motor assembly 48. The plurality of support mounts 49 adheres the conveyer belt mechanism 40 to area of the enclosure 10 around the litter box opening 12. The plurality of support mounts49 can include, but are not limited to, L-shaped brackets with a plurality of holes that allow a fastener to be inserted.

As can be seen in FIG. 9 and FIG. 22, the conveyer belt cleaning device 50 of the conveyer belt mechanism 40 comprises a blade 51, a blade axle 52, and a plurality of bearings 53. The conveyer belt cleaning device 50 is mounted within the first support panel 41 and second support panel 42 of the conveyer belt mechanism 40 through the blade axle 52. The blade axle 52 of the conveyer belt cleaning device 50 is centrally positioned on the first support panel 41 and the second support panel 52 of the conveyer belt mechanism 40, underneath the drive belt 45. The blade axle 52 can include, but is not limited to, a threaded rod, a tube, etc. The present invention is not limited to this option and other shape and sizes of rods and blades can be used. A triangle-shaped device or a square-shaped device with curved walls and a tube center can also be used for a similar function. The blade axle 52 includes one of the plurality of bearings 53 on each end to secure the component to the first support panel 41 and second support panel 42. The blade axle also functions to allow the conveyer belt cleaning device 50 to sway back and forth in unison with the drive belt 45 to ensure that the blade 51 remains permanently in contact with the drive belt 45. The blade axle 52 is a hollow cylinder with the blade 51 being tangentially positioned on the blade axle 52. The blade 51 evenly makes contact with the surface of the drive belt 51 soiled with used litter. Additionally, the blade 51 comprises a coating 54 and a blade tip 55. The coating 54 is continuously distributed across the blade tip 55. Additionally, the coating 54 ensures that there is adequate friction between the blade 51 and the drive belt 45 to scrape the used litter off the drive belt 45 and into the receptacle 18 below. The positioning of the conveyer belt cleaning device 50 in the center of the conveyer belt mechanism 40 ensures that the used litter is evenly deposited into the receptacle 18, which reduces the number of times the user needs to remove the used litter. Additionally, the blade tip 55 continuously exerts pressure onto the drive belt 45 of the conveyer belt mechanism 40 so that the drive belt 45 can be further tightened. In other embodiments of the present invention, a plurality of conveyer belt cleaning devices 50 can be placed along the underside of the conveyer belt mechanism 40. More specifically, the conveyer belt cleaning device 50 comprises a plurality of blades 51 and a plurality of blade axles 52. Each of the plurality of blades 51 is tangentially positioned on each of the plurality of blade axles 52. The plurality of blades 51 is distributed across the drive belt 45 of the conveyer belt mechanism 40, opposite the hopper 20, and each of the plurality of blade axles 52 is mounted within the first support panel 41 and the second support panel 42.

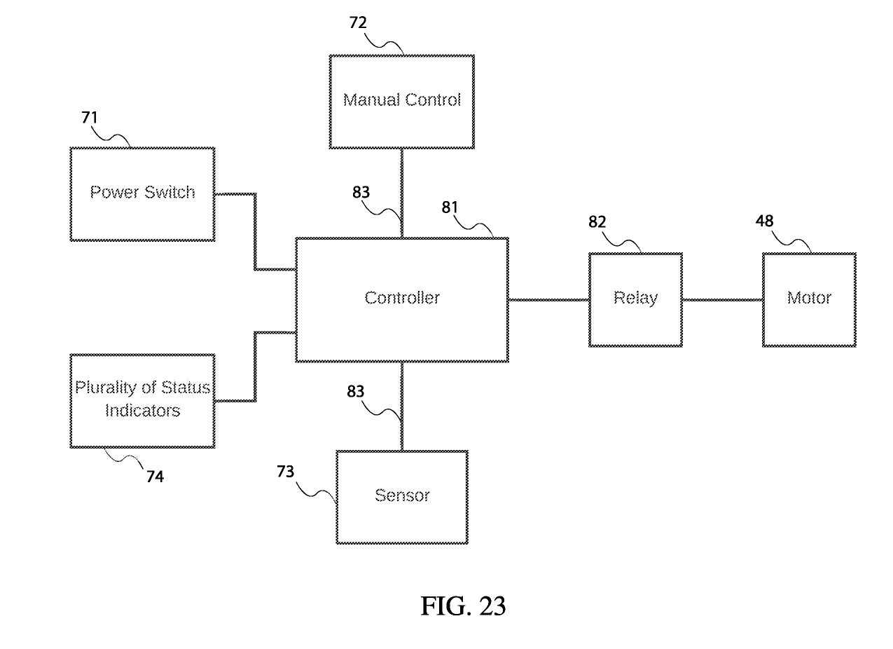

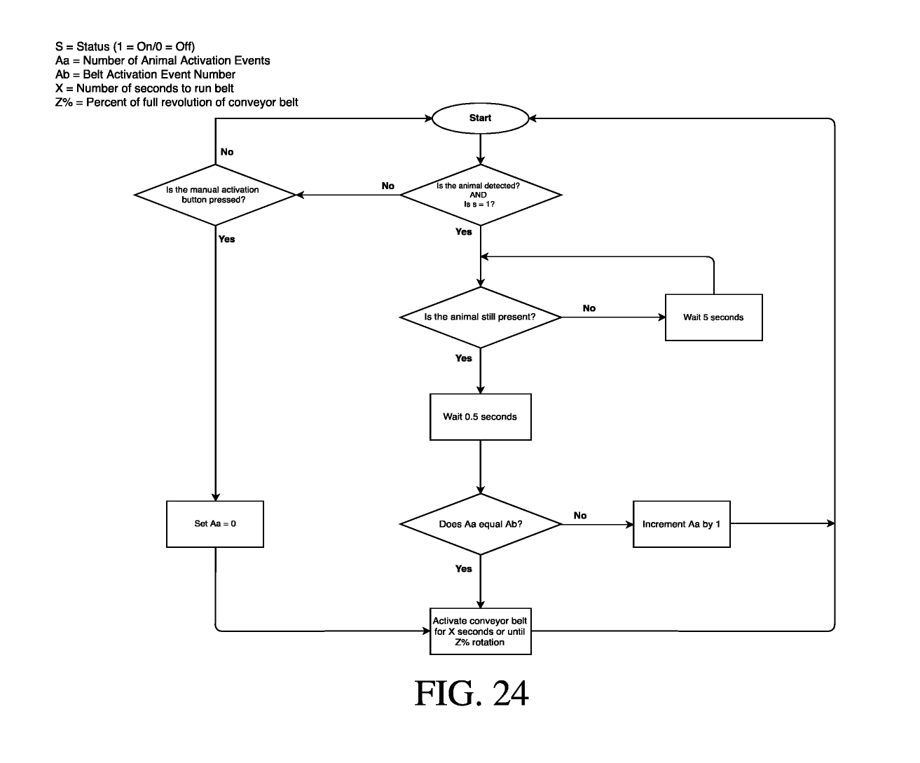

As can be seen in FIG.1 to FIG. 4, the control box 70 is mounted on the center of the outer surface of the hopper 20. The control box 70 comprises a power switch 71, a manual control 72, and a sensor 73. Additionally, the electronic box 80 is mounted to the first support panel 41 of the conveyer belt mechanism 40, adjacent the back 15 and the second side 17 of the enclosure 10. Additionally, the electronic box 80 is sealed from any dust, moisture, etc., to protect all interiorly installed components. The electronic box 80 comprises a controller 81, a relay 82, and a plurality of wires 83. The sensor 73 of the control box 70 and the relay 82 of the electronic box 80 are electrically connected to the controller 81 of the electronic box 80 to enable the autonomous function of the present invention, as seen in FIG. 23. The electronic box 80 has a snap-on feature that allows the user to easily detach the electronic box 80 when the present invention requires cleaning. The electronic box 80 can be attached to a side of the hopper 20, however can also be mounted onto the enclosure 10 or supporting frame or may be fully integrated into the conveyer belt mechanism 40. The snap-on attachment method can be a hook-and-loop attachment, a snap-button, or any other means of removably attaching the electronic box 80. The controller 81 of electronic box 80 is an analog or digital device that is connected to the sensor 73 of the control box 70 and to the relay 82 via the plurality of wires 83. As seen in FIG. 24, a flowchart of the control method used by the controller 81 is presented. The sensor 73 can include, but is not limited to, an infrared, motion, noise, or any other kind of detection device that can sense the presence of an animal. When the sensor 73 detects the presence of an animal, a signal is sent to the controller 81. For as long as an animal is detected, the sensor 73 will send signals to the controller 81 at a predefined interval, including, but not limited to 2 minutes, 3 minutes, etc. When the controller 81 no longer receives signals from the sensor 73, the controller 81 will wait for a predefined time. The controller 81 keeps track of how many unique instances an animal was detected. The uniqueness of the automation of the present invention comes from the next step: after the controller 81 has waited for the predefined time, the controller compares the number of unique instances to a predefined number. Only when the number of unique instances equals the predefined number will the controller 81 send a signal to the relay 82 which in turn will send a signal to turn on the motor assembly 48 of the conveyer belt mechanism 40 for a predefined time or a predefined rotation. This control logic ensures that unnecessary litter is not wasted each time an animal uses the present invention. This also reduces the electricity usage of the present invention, thus reducing the operating cost for the user. The manual control 72 of the control box 70 is electrically connected to the controller 81 to allow the user to manually rotate the drive belt 45 of the conveyer belt mechanism if needed. In another embodiment, a sensor to detect the drive belt 45 position and drive 45 belt movement may be employed to confirm that the surface of the drive belt 45 has been cleared or to detect problems in functioning of the conveyer belt mechanism 40.

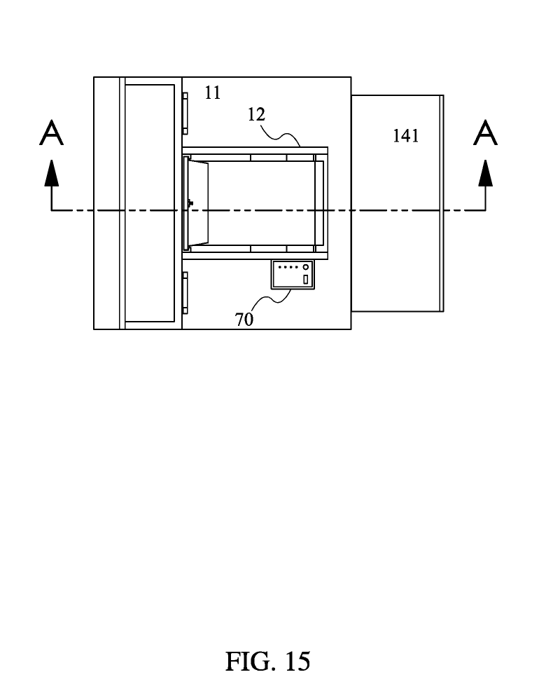

In the alternative embodiment of the present invention, as seen in FIG. 14 to FIG. 15, and FIG. 21, the control box 70 combines the electronic box 80. More specifically, the control box 70 is mounted on the second support panel 42 of the conveyer belt mechanism 40, adjacent the second sliding slot 422. Additionally, the control box 70 comprises a plurality of status indicators 74. The plurality of status indications 74 may include, but is not limited to, power on/off status, no motion/waiting detection of motion status, detected motion/waiting for a predefined delay to move the belt status, 3-minute non motion status, moving status, receptacle 18 full status, etc. Further, each of the plurality of status indicators may comprise, but is not limited to, LED (light-emitting diode), OLED (organic light-emitting diode), etc.

Although the invention has been explained in relation to its preferred embodiment, it is to be understood that many other possible modifications and variations can be made without departing from the spirit and scope of the invention as hereinafter claimed.

What is claimed is:

1. An automatic self-cleaning animal litter apparatus comprising:
an enclosure;
a hopper;
a conveyor belt mechanism;
the enclosure comprising a top plate, a litter box opening, a back, and a front;
the top plate being terminally connected to and supported by the front and back;
the litter box opening being positioned on the top plate;
the hopper being connected to the top plate and integrated into the side walls of the enclosure;
the hopper comprising a feed, an exit, and a spout assembly;
the exit being positioned between the edge of the litter box opening and the back of the enclosure;
the spout assembly comprising a plurality of spouts and a control valve;
the control valve being interiorly mounted to the hopper adjacent the exit;
the plurality of spouts being perpendicularly connected to the control valve;
the plurality of spouts being extended over the litter box opening of the enclosure;
the conveyor belt mechanism comprising a first support panel, a second support panel, a drive belt, a drive roller, a passive roller, a motor assembly, a conveyor belt cleaning device, a control box, and an electronic box;
the first support panel and the second support panel being mounted on and positioned across the top plate of the enclosure opposite to the hopper;
each of the drive roller and the passive roller being mounted within the first support panel and the second support panel, adjacent each end of the first support panel and the second support panel;
the drive belt being tightly wrapped around the drive roller and passive roller;
the drive belt being positioned beneath the exit of the hopper and stretched across the entire length of the litter box opening of the enclosure;
the motor assembly being exteriorly mounted to the first support panel, adjacent the drive roller;
the motor assembly being connected to the drive roller;
the conveyor belt cleaning device comprising a blade and a blade axle;
the blade axle being mounted within the first support panel and second support panel of the conveyor belt mechanism;
the blade axle being centrally positioned on the first support panel and second support panel;
the blade being tangentially positioned on the blade axle;
the blade being laterally in contact with the drive belt of the conveyor belt assembly opposite to the top plate of the enclosure;
the electronic box being mounted to the first support panel of the conveyer belt mechanism adjacent to the back of the enclosure;
the electronic box comprising a controller and a relay;
the control box being exteriorly mounted to the hopper adjacent the feed;
the control box comprising a sensor;
the sensor of the control box and the relay of the electronic box being electrically connected to the controller of the electronic box; and
the relay being electrically connected to the motor of the conveyor belt mechanism and the control valve of the spout assembly of the hopper.

2. The automatic self-cleaning animal litter apparatus as claimed in claim 1 comprising:
the front of the enclosure comprising a hinged door; and
the hinged door being positioned on the front with the hinge adjacent to the top plate.

3. The automatic self-cleaning animal litter apparatus as claimed in claim 1 comprising:
the enclosure comprising a first side, a second side, and a drawer;
the first and the second side being terminally mounted to the front and back; and
the drawer being interiorly mounted to the enclosure through the first side and second side.

4. The automatic self-cleaning animal litter apparatus as claimed in claim 1 comprising:
the enclosure comprising a receptacle; and
the receptacle being removably positioned inside the enclosure beneath the conveyor belt mechanism.

5. The automatic self-cleaning animal litter apparatus as claimed in claim 1 comprising:
the litter box opening of the enclosure comprising a plurality of walls; and
each of the plurality of walls being mounted to the top plate opposite the conveyor belt assembly.

6. The automatic self-cleaning animal litter apparatus as claimed in claim 5 comprising:
the litter box opening of the enclosure comprising a plurality of drapes; and
each of the plurality of drapes being terminally and exteriorly mounted to each of the plurality of walls.

7. The automatic self-cleaning animal litter apparatus as claimed in claim 1 comprising:
the control valve of the spout assembly comprising a manual control lever;
the manual control lever being perpendicularly mounted to the control valve; and
manual control lever being positioned outside the hopper.

8. The automatic self-cleaning animal litter apparatus as claimed in claim 1 comprising:
the control valve of the spout assembly comprising a slot;
the slot being longitudinally positioned across and traversing the control valve;
the control valve being mounted to the hopper adjacent the exit;
the spout assembly comprising a flexible wall and a non-flexible wall;
each of the plurality of spouts comprising a fastener, a spring, and a bearing;
the non-flexible wall being interiorly mounted to the hopper between the control valve and the exit of the hopper;
the fastener being perpendicularly mounted to the non-flexible wall;
each of the plurality of spouts being connected between the non-flexible wall and the flexible wall through the fastener;
the spring being concentrically positioned on the fastener between the flexible wall and the spout; and
the bearing being concentrically connected to the fastener adjacent the spring.

9. The automatic self-cleaning animal litter apparatus as claimed in claim 1 comprising:
the first support panel of the conveyor belt mechanism comprising a first sliding slot;
the second support panel of the conveyor belt mechanism comprising a second sliding slot;
the passive roller comprising a passive roller axle, a first tensioning spring, and a second tensioning spring;
the passive roller axle being positioned inside the first sliding slot of the first support panel and the second sliding slot of the second support panel;
the first tensioning spring being terminally connected to the passive roller axle;
the first tensioning spring being connected to the first support panel adjacent to the passive roller;
the second tensioning spring being terminally connected to the passive roller axle; and
the second tensioning spring being connected to the second support panel adjacent to the passive roller.

10. The automatic self-cleaning animal litter apparatus as claimed in claim 1 comprising:
the blade of the conveyor belt cleaning device of the conveyor belt mechanism comprising a coating and a blade tip;
the coating being continuously distributed across the blade tip; and
the blade tip being in contact with the drive belt of the conveyor belt mechanism.

11. The automatic self-cleaning animal litter apparatus as claimed in claim 10, wherein the blade tip continuously pressurizing the drive belt of the conveyor belt mechanism 40.

12. The automatic self-cleaning animal litter apparatus as claimed in claim 1 comprising:
the conveyor belt cleaning device comprising a plurality of blades and a plurality of blade axles;
each of the plurality of blades being tangentially positioned on each of the plurality of blade axles;
the plurality of blades being distributed across the drive belt of the conveyor belt mechanism, opposite the hopper; and
each of the plurality of blade axles being mounted within the first support panel and the second support panel.

13. The automatic self-cleaning animal litter apparatus as claimed in claim 1 comprising:
the motor assembly comprising a motor, a motor mount, a gear box, a drive roller axle connector;
the drive roller of the conveyor belt assembly comprising a drive roller bearing and a drive roller axle;
the drive roller bearing being concentrically connected to the drive roller axle;
the drive roller bearing being mounted on the first support panel;
the drive roller axle being concentrically connected to the driver roller connector;
the drive roller axle connector being connected to the motor through the gear box; and
the motor being mounted on the motor mount; and
the motor mount being mounted to the first support panel adjacent to the drive roller.

14. The automatic self-cleaning animal litter apparatus as claimed in claim 1 comprising:
the drive roller comprises a threaded drive roller axle;
the motor assembly comprising a motor, a motor mount, and a motor threaded shaft;
the motor being mounted on the motor mount;
the motor mount being mounted to the first support panel adjacent to the drive roller; and
the motor threaded shaft being concentrically and terminally connected to the threaded drive roller axle.

15. The automatic self-cleaning animal litter apparatus as claimed in claim 1 comprising:
the feed of the hopper comprising a hinged cover; and
the hinged cover being perimetrically connected to the hopper.

16. The automatic self-cleaning animal litter apparatus as claimed in claim 1 comprising:
the spout assembly comprising a slant board and a channel spout;
the slant board being positioned within the hopper, adjacent the exit;
the slant board comprising a first end and a second end;
the first end being positioned on the top plate of the enclosure, flush with the edge of the litter box opening of the enclosure;
the second end being positioned on the back of the hopper;
the channel spout comprising an inlet and an outlet;
the inlet of the channel spout being interiorly and slidably connected to the front of the hopper; and
the outlet of the channel spout being positioned outside the hopper and extended through the litter box opening of the enclosure to the drive roller of the conveyor belt assembly.

17. The automatic self-cleaning animal litter apparatus as claimed in claim 1 comprising:
the control box comprising a power switch, a manual control, and a plurality of status indicators and the electronic box; and
the status indicators and the manual control being electrically connected to the controller of the electronic box.

18. The automatic self-cleaning animal litter apparatus as claimed in claim 1 comprising:
the hopper comprising a hopper font, a hopper back, a hopper slot, and a slant board;
the hopper back being oriented flush to the back of the enclosure;
the hopper front being oriented perpendicular to the feed adjacent the exit;
the slant board being positioned within the hopper front and the hopper back in an angle with the back side elevated;
the slant board interiorly traversing across the hopper from side to side of the hopper;
the spout assembly comprising a channel spout, a base board, a positioning block, a plurality of sliding channels, a spout slot, a threaded rod, a sliding board, a sliding slot, a fastening nut;
the spout slot being longitudinally positioned across the base board;
the positioning black being terminally and longitudinally connected to the base board, adjacent the spout slot;
each of the plurality of sliding channel being terminally and laterally positioned on the base board;
the threaded rod being centrally positioned on the base board adjacent the sliding slot;
the base board being mounted to the hopper front;
the base board being positioned with the positioning block against the exit;
the spout slot being aligned with the hopper slot;
the sliding slot being centrally and laterally positioned on the sliding board;
the channel spout being terminally and longitudinally connected to the sliding board adjacent the sliding slot;
one end of the channel spout traversing the sliding board;
the channel spout being oriented above the litter box opening of the enclosure;
the sliding board being positioned on the base board with both edges slidably engaging the plurality of sliding channels of the base board; and
the fastening nut fastening the sliding board onto the base board through the threaded rod;
